(19) United States
(12) Patent Application Publication
(10) Pub. No.: US 2010/0328097 A1
(43) Pub. Date: Dec. 30, 2010

(54) UTILITY DATA OVER BROADBAND INFRASTRUCTURE

(75) Inventors: Travis Leo, Littleton, CO (US); Steven M. Casey, Littleton, CO (US)

Correspondence Address: Qwest Communications International Inc., 1801 California St., #900, Denver, CO, 80202, US

(73) Assignee: Qwest Communication International Inc., Denver, CO (US)

(21) Appl. No.: 12/491,108

(22) Filed: Jun. 24, 2009

(51) Int. Cl. G08C 15/06

(52) U.S. Cl. 340/870.02

(57) ABSTRACT

A method for reading a utility meter utilizing broadband infrastructure is provided. The method may include transmitting utility usage data from a plurality of customer premises to a remote enclosure, coupled with a utility pole, using a power line communications infrastructure. The utility usage data may be received at the remote enclosure. The remote enclosure may include a digital subscriber line (“DSL”) modem for modulating the utility usage data. The modulated utility usage data may be transmitted over a public broadband network infrastructure to a utility provider.

### BACKGROUND

This invention relates generally to methods and systems for transmitting utility usage data to a utility provider. More specifically, the invention relates to transmitting utility usage data to a utility provider using broadband infrastructures.

Traditionally, utility meter reading has involved a utility company sending a technician out to a customer premises to visually read the utility meter. Radio frequency technology has made the process somewhat easier by allowing a technician to drive through a neighborhood with a radio receiver and gather utility meter readings that are transmitted over a radio frequency from the utility meter to the technician's receiver. Both of these techniques require substantial human interaction, resulting in increased cost and decreased convenience. Moreover, neither of these methods is amenable to real-time meter reading.

At the same time, technologies have developed to allow utility customers to monitor and manage different devices and appliances within their homes. However, these technologies currently are limited to individual users implementing their own Home Automated Networks using private Home Networking mechanisms such as X10, Z-Wave, and Zigbee. To date, however, such technologies have been implemented on an individual scale and cannot benefit from centralized monitoring and/or management capabilities; further, because there is no interface between such technologies and current information about utility rates, the potential benefits of such technologies have not been maximized.

There is thus a need for tools and techniques that allow utility providers to collect meter readings without a technician having to visit a customer premises. It would be advantageous, in some situations, for such tools and techniques to provide centralized and/or decentralized monitoring, managing, and controlling of device usage, including but not limited monitoring resource consumption of individual devices, in the home.

### BRIEF SUMMARY

Certain embodiments thus provide tools and techniques to provide automatic and/or real-time meter reading along with centralized monitoring, managing, and controlling of device usage in a home. Embodiments may use multiple broadband infrastructures and networks. One broadband infrastructure may transmit meter readings to a remote enclosure. For example, a power line communication infrastructure such as broadband over power line may be used. From the remote enclosure, a DSL modem may then transmit the meter readings over a public broadband network infrastructure to a utility provider. These multiple broadband infrastructures may also be used by a utility provider to control, monitor, and/or manage the devices at a customer premises. Monitoring devices at a customer premises may include but is not limited to monitoring a resource consumption by a device.

Embodiments may take advantage of existing broadband infrastructures. Merely by way of example, embodiments may utilize an existing local loop of a public switched telephone network (“PSTN”). The local loop may be connected to a DSL modem at the remote enclosure. Embodiments may also utilize power lines between a customer premises and a utility pole to transmit meter readings. Furthermore, a remote enclosure that may include the DSL modem may be coupled with a utility pole. The utility pole may have existing connections to the power lines connected to a customer premises. Furthermore, the utility pole may provide connections to the PSTN through a local loop. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments.

In one embodiment, a method for reading a utility meter utilizing broadband infrastructure is provided. The method may include transmitting utility usage data from a plurality of customer premises to a remote enclosure, attached to a utility pole, using a power line communications infrastructure. The utility usage data may be received at the remote enclosure. The remote enclosure may include a digital subscriber line (“DSL”) modem for modulating the utility usage data. The modulated utility usage data may be transmitted over a public broadband network infrastructure to a utility provider.

In another embodiment, a method for determining utility usage utilizing broadband infrastructure is provided. The method may include transmitting utility usage data from at least one customer premises to a remote enclosure using a first communications infrastructure and/or network. The utility usage data may be received at the remote enclosure. The remote enclosure may include a modem for modulating the utility usage data to be transmitted over a second communications infrastructure and/or network. The utility usage data may be modulated with the modem. The modulated utility usage data may be transmitted over the second communications infrastructure and/or network to a receiving entity.

In another embodiment, a system for reading a utility meter utilizing broadband network is provided. The system may include a utility meter in communication with a first communications network. A remote enclosure may communicate with the utility meter through the first communications network. The remote enclosure may include a digital subscriber line (“DSL”) modem. The DSL modem may be in communication with a local loop of a public switched telephone network (“PSTN”). The DSL modem may modulate utility usage data received at the remote enclosure. The modulated utility usage data may be transmitted through the local loop of the PSTN to a utility provider.

### BRIEF DESCRIPTION OF THE DRAWINGS

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

FIG. 1 illustrates a system for transmitting utility usage data to a server using a remote enclosure and a broadband infrastructure, in accordance with various embodiments.

FIG. 2 illustrates a system for transmitting utility usage data from a plurality of customer premises to a server using a remote enclosure and a broadband infrastructure, in accordance with various embodiments.

FIG. 3 illustrates a system for wirelessly transmitting utility usage data from a plurality of customer premises to a remote enclosure and then to a server using a broadband infrastructure, in accordance with various embodiments.

FIG. 4 illustrates a block diagram for methods of transmitting utility usage data to a receiving entity using a remote enclosure and a broadband infrastructure, in accordance with various embodiments.

FIG. 5 illustrates a block diagram for methods of transmitting control data from a receiving entity to a customer premises using a remote enclosure and a broadband infrastructure, in accordance with various embodiments.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It should be understood that various changes may be made in the function and arrangement of elements without departing from the spirit and scope of the invention as set forth in the appended claims. Several embodiments are described herein, and while various features are ascribed to different embodiments, it should be appreciated that the features described with respect to one embodiment may be incorporated within other embodiments as well. By the same token, however, no single feature or features of any described embodiment should be considered essential to every embodiment of the invention, as other embodiments of the invention may omit such features.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, various embodiments may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

In one embodiment, a method for reading a utility meter utilizing broadband infrastructure is provided. The method may include transmitting utility usage data from a plurality of customer premises to a remote enclosure using a power line communications infrastructure. The utility usage data may be received at the remote enclosure. The remote enclosure may include a digital subscriber line (“DSL”) modem for modulating the utility usage data. The modulated utility usage data may be transmitted over a public broadband network infrastructure to a utility provider.

In another embodiment, a method for determining utility usage utilizing broadband infrastructure is provided. The method may include transmitting utility usage data from at least one customer premises to a remote enclosure using a first communications infrastructure and/or network. The utility usage data may be received at the remote enclosure. The remote enclosure may include a modem for modulating the utility usage data to be transmitted over a second communications infrastructure and/or network. The utility usage data may be modulated with the modem. The modulated utility usage data may be transmitted over the second communications infrastructure and/or network to a receiving entity.

Utility usage data may include a wide variety of data including, without limitation, electricity usage data, water usage data, gas usage data, and/or smart device utility usage data. Usage data can include, for example, information about a quantity of electricity, water, gas, etc. used, information about a rate of use, information about a time period of use, and/or the like. In a particular example, a set of utility usage data might specify that a customer premises had consumed a particular volume (or mass) of natural gas over a particular time period (such as 12:00 am to 6:00 am on a particular date). In another particular example, a set of utility usage data might specify that a customer premises had consumed a quantity of electricity, which may be measured in kilowatt-hours for example, over a particular period of time. In some embodiments, usage data may be information about a rate of use of a quantity of electricity, gas, water, etc. In one particular example, a set of utility usage data might specify that a customer premises may be consuming electricity at a certain rate, which might be measured in watts for example. In some embodiments, usage data may reflect power generation at a customer premises, In some embodiments, utility usage data may be transmitted from a single customer premises to a remote enclosure, while in other embodiments, utility usage data may be transmitted from multiple customer premises to a remote enclosure. Some embodiments may include data compression, archiving, processing, and/or reporting.

In some embodiments, usage decisions may be determined based on utility usage data or other factors. Merely by way of example, a decision may be made to turn a device on or off at a customer premises based on the cost of using a device at a particular time. The cost of using a device may be based on a current cost of a resource to operate the device. Merely by way of example, a decision to operate an electrical appliance such as an air conditioner or dish washer may be based on the price of electricity at a particular time. A decision to turn off a device may be made based on the demand for the resource used to operate the device for example. A decision to turn a device off may be made based on the utility usage data transmitted to a receiving entity for example. As discussed in more detail below, the systems, methods, and apparatuses disclosed in different embodiments may provide means for controlling a device in order to affect a usage decision. In addition, a customer may utilize utility usage data and/or other factors to control devices at the customer premises.

The utility usage data may be transmitted from a customer premises to a remote enclosure over a first communications infrastructure and/or network. In some embodiments, a first communications infrastructure and/or network may include power line communications (“PLC”) infrastructure and/or network. A PLC infrastructure and/or network may include broadband over power line (“BPL”) communication. PLC in general may involve impressing a modulated carrier signal along a wiring system. In some embodiments, a first communications infrastructure and/or network such as PLC may connect through a utility meter, located proximate to a customer premises, to a remote enclosure through power lines that may provide electricity to the customer premises.

Transmitting utility usage data from a customer premises to a remote enclosure may involve other types of first communications infrastructures and/or networks. Merely by way of example, utility usage data may be transmitted wirelessly from a customer premises to a remote enclosure. A wireless client, such as a WiFi client, may be located at the customer premises. The wireless client may be coupled with a utility meter in order to transmit data from the utility meter to the remote enclosure. The remote enclosure may include a wireless access point capable of receiving utility usage data transmitted from the wireless client located at a customer premises. The wireless access point may be housed within the remote enclosure. In some embodiments, the wireless access point may be attached to the remote enclosure, or may be separate from the remote enclosure, yet coupled with the remote enclosure in order to transmitted utility usage data to the remote enclosure from the customer premises.

Wireless client(s) and/or wireless access point(s) may communicate through a variety of wireless communications technologies. Merely by way of example without limitation, the wireless communications technology may include infrared transmissions, radio frequency (“RF”) transmissions (including encoder-receiver-transmitter (“ERT”)), and transmissions complying with standards developed by any of the IEEE's working groups governing wireless communication (e.g., the 802.11, 802.15, 802.16, and 802.20 working groups)

A remote enclosure may be coupled with a utility pole in some embodiments. Some embodiments' remote enclosure coupled with a utility pole may be physically attached to the utility pole. The remote enclosure may receive power from a power line provided at the utility pole. The remote enclosure may house a modem. In some embodiments, the remote enclosure may include a switch and/or router coupled with the modem. A switch and/or router may be integrated with the modem in some embodiments, while in other embodiments, a switch and/or router and/or modem may be separate devices. The remote enclosure may be designed to withstand weather variations, such as temperature and precipitation changes. Some embodiments may utilize temperature control capabilities and/or appropriate shielding to protect the modem and other devices housed within the remote enclosure against the elements. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments.

A remote enclosure may be located in a position in order to receive utility usage data from multiple customer premises in some embodiments. Utility usage data may be aggregated at the remote enclosure from the multiple customers. In some embodiments, a remote enclosure may be located separately from a utility pole, yet proximate enough to a second communications infrastructure as to be able to transmitted utility usage data to a receiving entity.

A remote enclosure may include a modem utilized for modulating utility usage data to be transmitted over a second communications infrastructure and/or network. A modem may include a digital subscriber line (“DSL”) modem. The DSL modem may be in communication with a second communications infrastructure and/or network. In some embodiments, a modem may include a cable modem. In some embodiments, a modem may be a wireless modem. Merely by way of example, a DSL modem may be in communication with a local loop of a public switched telephone network comprising a second communications infrastructure and/network. A local loop may be in communication with a DSL distribution point as part of a second communications infrastructure and/or network. A DSL distribution point may include a digital subscriber line access multiplexer (“DSLAM”). A second communications infrastructure and/or network may include a public access network infrastructure. A public network may include the Internet. The DSL modem may also be coupled with a switch and/or router through which it may receive the utility usage data from the first communications infrastructure and/or network.

The utility usage data may be modulated by the modem. The utility usage data may then be transmitted over the second communications network to a receiver. The utility usage data may also be transmitted securely. In some embodiments, the utility usage data may be encrypted. In some embodiments, the utility usage data may be transmitted securely by transmitting the data over a virtual private network (“VPN”). Merely by way of example, other methods of sending utility usage data securely may include using protocols such as secure sockets layer (“SSL”) and hypertext transfer protocol secure (“HTTPS”). Methods, systems, and devices may also utilize static IP addressing. One skilled in the art will recognize that other methods for sending data securely over a network may be applied with these methods and systems. In some embodiments, the data may be transmitted over a private network utilizing an existing public network and/or DSL infrastructure. Transmitting the data over such a private network may utilize a private host circuit. Merely by way of example, such a private network may involve putting a virtual path identifier (“VPI”) and a virtual circuit identifier (“VCI”) into a modem. The data may be aggregated at a local access and transport area (“LATA”) level and then sent directly to a receiver. In some embodiments, a private network may involve putting a virtual local area network (“VLAN”) identifier into a modem.

The modulated utility usage data, which may be secure in some embodiments, may be transmitted over a second communications infrastructure and/network to a receiving entity. A receiving entity may include a utility provider, a service provider such as a provider who provides access to a communications infrastructure and/or network, a utility services provider who may provide services to a utility provider and/or a utility customer, and/or a customer such as a customer of a utility provider, a service provider, and/or a utility services provider.

Utility usage data may also include identification information in order to associate the utility usage data with a particular customer and/or a particular utility usage meter and/or device. In some embodiments, identification information may be associated with the particular customer and/or the particular utility usage meter and/or the particular device. Merely by way of example, a utility usage meter may have a unique identification associated with it. In some embodiments, the utility usage meter with a unique identification may be able to connect with a variety of different communication networks in order to transmit utility usage data to a provider, where the transmitted utility usage data includes information regarding the utility usage meters identification. Some embodiments may also utilize IP matching. This identification information may also be encrypted and/or transmitted securely.

In some embodiments, data may be transmitted from a receiving entity to a customer premises. Data transmission may be bi-directional and/or two-way communication in some embodiments. A receiving entity may transmit data to the remote enclosure through the second communications infrastructure and/or network. From the remote enclosure, the data may be transmitted through a first communications infrastructure and/or network to a customer premises. The data may be used to control, monitor, and/or maintain utility-related devices at a customer premises. Merely by way of example, the control data may be used to control, monitor, or maintain smart devices at a customer premises. Some embodiments may include displaying utility usage data and/or control data information at a customer premises.

Data transmitted from a receiving entity may also be used to prompt a device to transmit data back to the receiving entity. Merely by way of example, some utility meters, such as water and gas meters, may be configured to only provide data when they receive a wake up signal from a utility provider making the rounds to gather meter readings. In some embodiments then, a receiving entity may transmit a wake up signal through the communications infrastructures and the remote enclosure to the utility meter, prompting it to wake up and provide data, such as a meter reading.

Data transmitted from a receiving entity may also be used to control when a device, such as an appliance is turned on or turned off. Merely by way of example, an air conditioner appliance may be turned off using such control data when the cost and/or demand for electricity reaches certain levels. A receiving entity, such as a utility provider or even a customer, may use this method and system to prompt appliances to turn on or off based on the cost of running the appliance based on the cost of using the resource provided by a utility company. Many other purposes may prompt a receiving entity to transmit data through the system to the customer premises such as to remotely control devices, turning on devices for security reasons, monitoring devices to determine utility usage, and/or maintaining devices.

The disclosed methods discussed above also provide for systems for reading utility meters and/or determining utility usage utilizing broadband infrastructure. All the previously discussed method steps and their elements may be included in systems for determining utility usage utilizing broadband infrastructure.

In another embodiment, a system for reading a utility meter utilizing broadband network is provided. The system may include a utility meter in communication with a first communications network. A remote enclosure may communicate with the utility meter through the first communications network. The remote enclosure may include a digital subscriber line (“DSL”) modem. The DSL modem may be in communication with a local loop of a public switched telephone network (“PSTN”). The DSL modem may modulate utility usage data received at the remote enclosure. The modulated utility usage data may be transmitted through the local loop of a PSTN onto a utility provider. The system may include multiple remote enclosures in some embodiments.

As discussed more thoroughly above with respect to methods for determining utility usage using broadband infrastructure, a utility meter may include an electricity, gas, and/or water meter. In some embodiments, a utility meter may include the ability to monitor smart devices at a customer premises. In some embodiments, a utility meter may be a more general purpose data measuring device, capable of measuring different data at a customer premises, such as the use of different devices at a customer premises.

As discussed more thoroughly above with respect to methods for determining utility usage using broadband infrastructure, a remote enclosure may be in communication with a utility meter and/or other data measuring device at a customer premises through a variety of different communication infrastructures and/or networks. Merely by way of example, the communications infrastructure and/or network may be a power line communications (“PLC”) infrastructure and/or network. In some embodiments, a PLC may be a broadband over power line (“BPL”). In other embodiments, the communications infrastructure and/or network may be based on wireless communication technologies.

Some embodiments may include a remote enclosure that may be coupled with a utility pole. In some embodiments, a remote enclosure coupled with a utility pole may be physically attached to a utility pole. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments.

As discussed more thoroughly above with respect to methods for determining utility usage using broadband infrastructure, embodiments of systems may also involve data being transmitted from a receiving entity, such as a utility provider, to a customer premises. Data transmission may be bi-directional in some embodiments. A receiving entity may transmit data to the remote enclosure through the second communications infrastructure and/or network, such as the PSTN and local loop. From the remote enclosure, the data may be transmitted through the first communications infrastructure and/or network, such as a PLC or wirelessly, to a customer premises. The data may be used to control, monitor, and/or maintain utility-related devices at a customer premises. Merely by way of example, the control data may be used to control, monitor, or maintain smart devices at a customer premises. In some embodiments, a receiving entity may transmit data to the remote enclosure and then to the customer premises through different communications infrastructures and/or networks than data that may be transmitted from a customer premises to the remote enclosure and then the receiving entity.

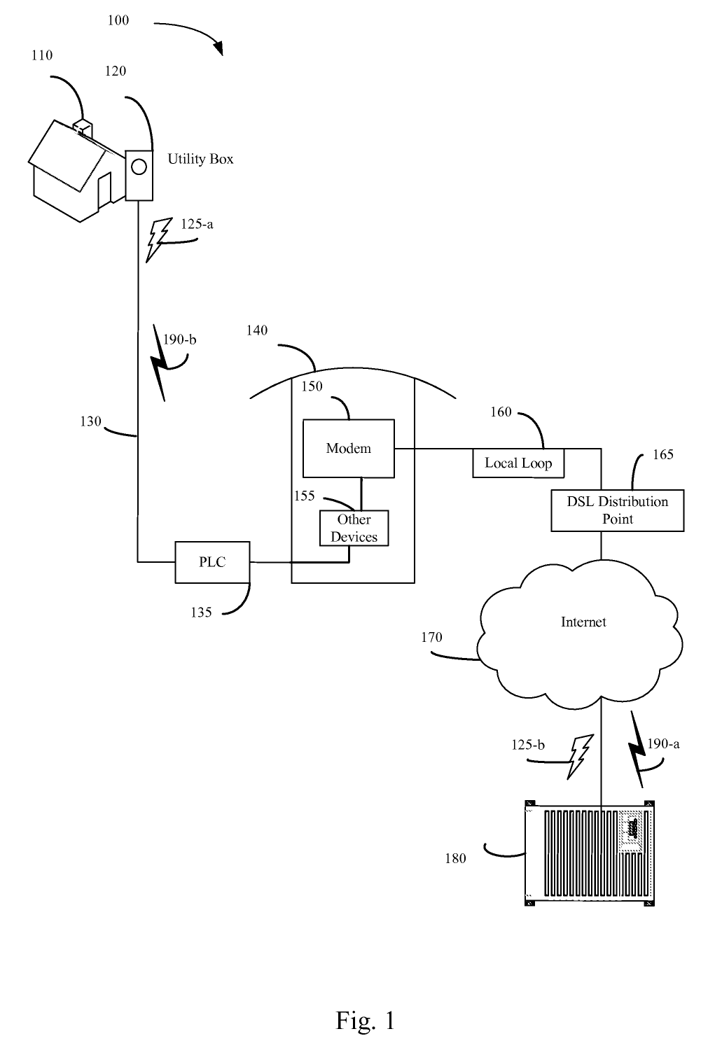

Turning now to FIG. 1, a system 100 for reading a utility meter using broadband infrastructure is shown. Customer premises 110 is in communication with utility box 120. Utility box 120 may be in communication with a power line communication (“PLC”) network (not shown) at customer premises 1 10. Utility box 120 may be, merely by way of example, an electricity meter, water meter, a gas meter, and/or other utility usage meters. Utility box 120 may be able to communicate with smart devices (not shown) at customer premises 110, as through a PLC network, for example.

From utility box 120, utility usage data 125-a may be transmitted along communication lines 130 to remote enclosure 140. Communication lines 130 may be power lines providing electrical power to customer premises 110. Communication lines 130 may be part of a PLC network between customer premises 110 and remote enclosure 140. PLC may be broadband over power line (“BPL”) in some embodiments.

Communication lines 130 that transmit utility usage data over PLC may include additional components and/or devices 135 to facility communication to remote enclosure 140. Merely by way of example, additional components and/or devices 135 may include, but are not limited to, repeaters, couplers providing transformer bypasses, bridges, and/or power components providing distributing power at remote enclosure 140. Other components involved with BPL may be associated with components 135. Communication lines 130 may be coupled with remote enclosure 140 either directly or indirectly.

Remote enclosure 140 may receive utility usage data 125-a being sent over communication lines 130. Remote enclosure 140 may include device(s) 155. Merely by way of example, device(s) 155 may include switches, routers, power cable interfaces, power connections, media converters, fiber interfaces, and/or temperature control components (such as heaters and air conditioning components). Remote enclosure 140 may include modem 150. Modem 150 may be a broadband modem. Modem 150 may be a DSL modem. Modem 150 may modulate utility usage data to be transmitted to receiving entity and/or server 180.

In some embodiments, remote enclosure 140 may be coupled with a utility pole. Some embodiments with remote enclosure 140 coupled with a utility pole may include remote enclosure 140 being physically attached to a utility pole. A utility pole may include, with limitation, a telephone pole and/or an electrical power line pole. Electricity may be provided to remote enclosure 140 and components/devices, such as 150 and/or 155, housed within or attached to remote enclosure 140 from power supply available at the utility pole. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments.

Modem 150, such as a DSL modem, may be in communication with local loop 160 of public switched telephone network (“PSTN”). Local loop 160 may be in communication with DSL distribution point 165. Local loop 160 and/or DSL distribution point 165 may be in communication with Internet 170. Receiving entity and related server(s) 180 may be in communication with modem 150 through local loop 160 and/or DSL distribution 165 and Internet 170.

Utility usage data 125-a may be received at remote enclosure 140. Modem 150 may modulate utility usage data 125 to be transmitted over a broadband infrastructure and/or network to a receiving entity, through a receiving entity-related server 180 for example. Broadband infrastructure and/or network may be part of a service provider's access network. Merely by way of example, a DSL modem may modulate utility usage data. Modulated utility usage data may be sent through local loop 160 of a PSTN. Modulated utility usage data may then be transmitted through DSL distribution point 165. Modulated utility usage data may be transmitted to Internet 170. Utility usage data 125-b, which may include utility usage data that may be included in the utility usage data 125-a, may be transmitted to receiving entity, where receiving entity may include server(s) 180 associated with receiving entity. Receiving entity may include a utility provider, a service provider, a utility services provider, and/or a customer, merely by way of example.

In some embodiments, receiving entity and/or related server(s) 180 may transmit data 190-a back to customer premises 110 using the systems disclosed. Embodiments may have two-way communication. Merely by way of example, receiving entity may send control, monitoring, and/or maintenance data 190-a through Internet 170 from server 180 to remote enclosure 140. Receiving entity data 190 may be transmitted through local loop 160 to remote enclosure 140 and associated modem 150. Receiving entity data 190-b, which may include data that may be included in receiving entity data 190-a, may be transmitted from modem 150 along communication lines 130 to utility box 120. Receiving entity data 190-b may be transmitted at customer premises 110 to control devices, appliances, and/or other equipment at customer premises 110. Merely by way of example, receiving entity data 190 may be used to control, monitor, and/or maintain smart devices at customer premises. In some embodiments, data being sent to customer premises 110 may not necessarily have to come from a receiving entity. In some embodiments, an entity besides a receiving entity may send data 190 through remote enclosure 140 to customer premises 110.

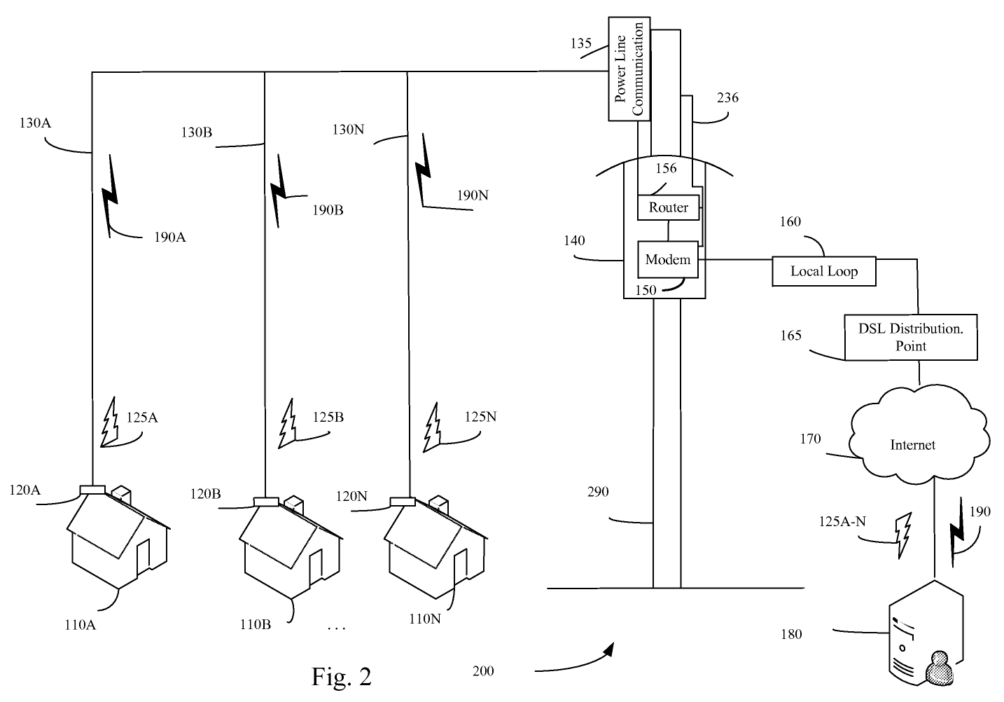

FIG. 2 provides another embodiment of a system 200 for determining utility usage using broadband infrastructure. System 200 may be an example of system 100 of FIG. 1. System 200 shows multiple customer premises 110A-N that may have utility usage data 125A-N sent to a receiving entity 180 from utility boxes 120A-N. Communication lines 130A-N may run to each customer premises 110A-N. Utility usage data 125A-N may be transmitted along communication lines 130 using PLC. PLC may include BPL. System 200 may include components and/or devices 135 to facility PLC to remote enclosure 140 and/or to facility BPL communication. System 200 may include utility pole 290. Remote enclosure 140 may be coupled with utility pole 290, which may include physically attaching remote enclosure 140 to utility pole 190. Power line 236 at utility pole 290 may provide power to remote enclosure 140 and components 150 and 156 within remote enclosure 140. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments. As also seen within FIG. 1, modem 150 and other components 155, such as a router 156, within remote enclosure 140 may be in communication with local loop 160, DSL distribution point 165, and/or Internet 170. Merely by way of example, router 156 may direct utility usage and/or control data between specific customer premises 110 and modem 150. Utility usage data 125A-N may be transmitted to receiving entity and/or associated server(s) 180 through system 200. Utility usage data 125A-N may include identification information such that receiving entity can differentiate data coming from different customer premises. Utility usage data 125A-N may also be encrypted and/or transmitted securely through system 200. Merely by way of example, utility usage data may be transmitted over VPN, SSL, HTTPS, and/or other secure methods for transmitting data over broadband network and/or Internet 170 to a receiving entity. In some embodiments, the data may be transmitted over a private network utilizing an existing public network and/or DSL infrastructure. Transmitting the data over such a private network may utilize a private host circuit. Merely by way of example, such a private network may involve putting a virtual path identifier (“VPI”) and a virtual circuit identifier (“VCI”) into a modem. The data may be aggregated at a local access and transport area (“LATA”) level and then sent directly to a receiver. In additional, data such as control, monitoring, and/or maintenance data 190, 190A-N may be sent from receiving entity and/or associated server(s) 180 back to customer premises 110A-N.

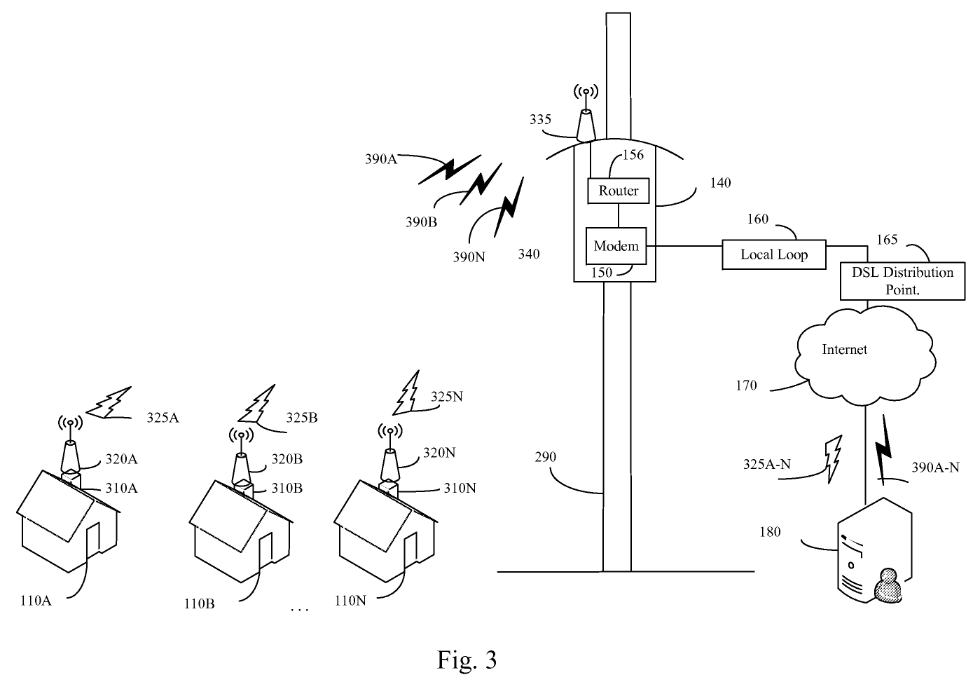

FIG. 3 provides a system 300 for determining utility usage using broadband infrastructure. System 300 may be an example of system 100 of FIG. 1, utilizing wireless communication from customer premises to a remote enclosure. Customer premises 110A-N may transmit utility usage data 325A-N (for example, see utility usage data 125) wirelessly to remote enclosure 340 (for example, see remote enclosure 140). Customer premises 110A-N may include wireless clients 320A-N in communication with utility usage devices 310A-N (for example, see utility box 110) associated with customer premises 110A-N. Merely by way of example, utility usage devices 320A-N may be utility meters and/or other data collecting devices. In some embodiments, wireless clients 320A-N may be radio frequency receiver/transmitter such as encoder-receiver-transmitter (“ERT”) used by utility providers to gather utility usage data from utility meters using radio frequency transmitter and receiver equipment. In other embodiments, wireless clients 320A-N may be WiFi clients. One skilled in the art will recognize that the wireless clients 320A-N may employ different wireless transmission technologies and protocols. Merely by way of example, but not limited to, wireless clients 320A-N may utilize wireless transmission technologies including infrared transmissions, radio frequency (“RF”) transmissions (including encoder-receiver-transmitter (“ERT”)), and transmissions complying with standards developed by any of the IEEE's working groups governing wireless communication (e.g., the 802.11, 802.15, 802.16, and 802.20 working groups).

Remote enclosure 340 may include a wireless access point 335 for receiving utility usage data 325A-N transmitted from customer premises 110A-N from wireless clients 320A-N. Wireless access point 335 may be coupled with remote enclosure 340. In some embodiments, wireless access point may be attached to remote enclosure 340. Some embodiments may have wireless access point 335 housed within remote enclosure 340. In other embodiments, wireless access point 335 may be attached to utility pole 290 and in communication with modem 150 in remote enclosure 340. In some embodiments, the wireless access point 335 may be coupled with a utility box in addition to a utility pole or instead of a utility pole. The utility box to which wireless access point 335 may be coupled may be remote from a customer premises in some embodiments. The utility box may be underground or above ground in some embodiments. The utility box may be coupled with multiple customer premises in some embodiments. Merely by way of example, wireless access point 335 may be a WiFi access point. Wireless access point 335 may utilize other wireless communications technologies utilized by wireless clients 320A-N. In some embodiments, wireless access point 335 may be configured to receive and transmit using ERT signals. Receiving entity and/or associated server(s) 180 may transmit data 390A-N (see data 190 for example) such as control, monitoring, and/or maintenance data to customer premises 110A-N through system 300.

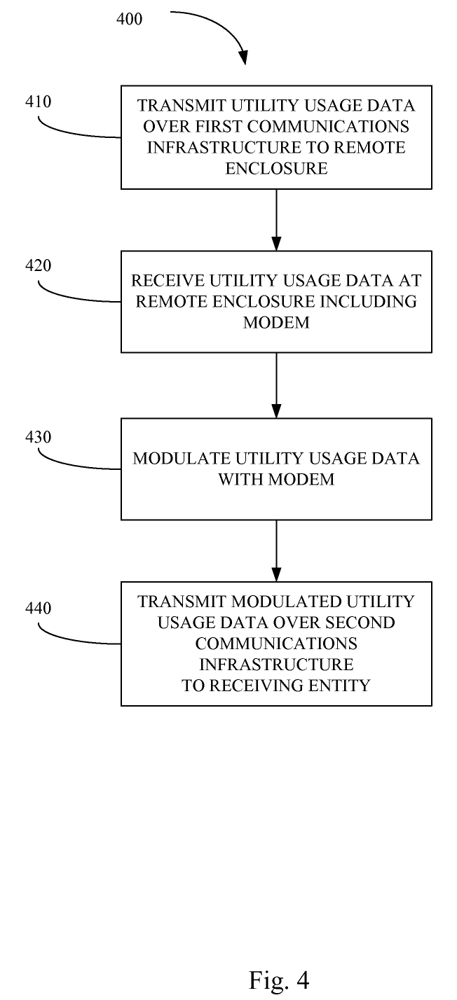

FIG. 4 illustrates a method 400 of reading a utility meter. Method 400 may be implemented in systems such as system 100, 200, and/or 300. Method 400 may utilize aspects described in more detail above, including aspects of systems 100, 200, and/or 300 without limitation. For example, in an aspect, method 400 may be implemented using a broadband infrastructure. In one embodiment, method 400 may include transmitting utility usage data from at least one customer premises to a remote enclosure (block 410). In some cases, utility usage data may be transmitted from a plurality of customer premises to the remote enclosure. This transmission may be performed with a first communications infrastructure. In some cases, the first communications infrastructure may be a PLC infrastructure. A PLC infrastructure may be a BPL infrastructure in some embodiments. In some cases, the first communications infrastructure may be a wireless infrastructure Wireless infrastructure may include wireless client(s) and/or wireless access point(s) that may communicate through a variety of wireless communications technologies. Merely by way of example, the wireless communications technology may include infrared transmissions, radio frequency (“RF”) transmissions (including encoder-receiver-transmitter (“ERT”)), and transmissions complying with standards developed by any of the IEEE's working groups governing wireless communication (e.g., the 802.11, 802.15, 802.16, and 802.20 working groups).

Utility usage data transmitted to a remote enclosure (block 410) of method 400 may include a wide variety of data including, without limitation, those types of utility usage data described above.

Method 400 may further include receiving the utility usage data at the remote enclosure (block 420). The remote enclosure may include a modem for modulating the utility usage data. The remote enclosure may be coupled with a utility pole in some embodiments. Some embodiments involving a remote enclosure coupled with a utility pole may include the remote enclosure physically attached to the utility pole. The remote enclosure may receive power from a power line dropped from the utility pole. In some embodiments, the remote enclosure may be coupled with a utility box in addition to a utility pole or instead of a utility pole. The utility box to which a remote enclosure may be coupled may be remote from a customer premises in some embodiments. The utility box may be underground or above ground in some embodiments. The utility box may be coupled with multiple customer premises in some embodiments. The remote enclosure may house a modem. In some embodiments, the remote enclosure may include a switch and/or router coupled with the modem. Some embodiments may involve the remote enclosure being designed to withstand weather variations, including temperature and precipitation changes, including temperature control capabilities and/or appropriate shielding to protect the modem and other devices housed within the remote enclosure against the elements.

In some embodiments, method 400 may include a remote enclosure receiving utility usage data (block 420) that may be located in position in order to receive utility usage data from multiple customer premises. Utility usage data may be aggregated at the remote enclosure from the multiple customers. In some embodiments, a remote enclosure may be located separately from a utility pole, yet proximate enough to a second communications infrastructure as to be able to transmitted utility usage data to a receiving entity.

A remote enclosure receiving utility usage data (block 420) of method 400 may include a modem utilized for modulating utility usage data to be transmitted over a second communications infrastructure and/or network. A modem may include a digital subscriber line (“DSL”) modem in some embodiments. A DSL modem may be in communication with a second communications infrastructure and/or network. In some embodiments, a modem may include a cable modem. Merely by way of example, a DSL modem may be in communication with a local loop of a public switched telephone network comprising a second communications infrastructure and/network. A local loop may be in communication with a DSL distribution point as part of a second communications infrastructure and/or network. A DSL distribution point may include a digital subscriber line access multiplexer (“DSLAM”). The DSLAM may be a remote DSLAM or in a central office. A second communications infrastructure and/or network may include a public access network infrastructure. A public network may include the Internet. The DSL modem may also be coupled with a switch and/or router through which it may receive the utility usage data from the first communications infrastructure and/or network.

Method 400 may further include modulating the utility usage data with a modem (block 430). The utility usage data may then be transmitted over the second communications network to a receiver. The utility usage data may also be transmitted securely. In some embodiments, the utility usage data may be encrypted. In some embodiments, the utility usage data may be transmitted securely by transmitting the data over a virtual private network (“VPN”). Merely by way of example, other methods of sending utility usage data securely may include without limitation using protocols such as secure sockets layer (“SSL”) and hypertext transfer protocol secure (“HTTPS”). In some embodiments, the data may be transmitted over a private network utilizing an existing public network and/or DSL infrastructure. Transmitting the data over such a private network may utilize a private host circuit. Merely by way of example, such a private network may involve putting a virtual path identifier (“VPI”) and a virtual circuit identifier (“VCI”) into a modem. The data may be aggregated at a local access and transport area (“LATA”) level and then sent directly to a receiver. One skilled in the art will recognize that other methods for sending data securely over a network may be applied with these methods and systems.

Method 400 may further include transmitting the modulated utility usage data over a communications infrastructure to a receiving entity (block 440). The modulated utility usage data, which may be secure in some embodiments, may be transmitted over a second communications infrastructure and/or network to a receiving entity. A receiving entity may include without limitation a utility provider, a service provider such as a provider who provides access to a communications infrastructure and/or network, a utility service provider who may provide services to a utility provider and/or a utility customer, and/or a customer such as a customer of a utility provider, a service provider, and/or a utility services provider.

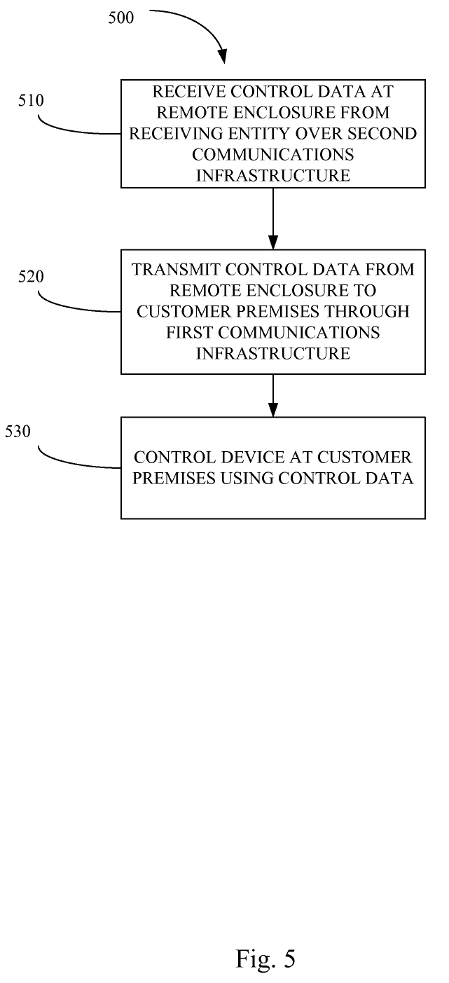

FIG. 5 illustrates a method 500 of reading a utility meter that also allows for monitoring, controlling, and/or maintaining devices at customer premises. Method 500 may be implemented in systems such as system 100, 200, and/or 300. Method 500 may utilize aspects describe in more detail above, including aspects of systems 100, 200, and/or 300 without limitation. In one embodiment, method 500 may include receiving control data (block 510). Data may be transmitted and received from a receiving entity to a customer premises. Data transmission may be bi-directional in some embodiments. A receiving entity may transmit data to the remote enclosure through a second communications infrastructure and/or network. From the remote enclosure, the data may be transmitted through a first communications infrastructure and/or network to a customer premises (block 520). The data may be used to control, monitor, and/or maintain utility-related devices at a customer premises (block 530). Merely by way of example, the control data may be used to control, monitor, or maintain smart devices at a customer premises.

In some embodiments, data received from a receiving entity (block 510) of method 500 may also be used to prompt a device to transmit data back to the receiving entity. Merely by way of example, some utility meters, such as water and gas meters, may be configured to provide data when they receive a wake up signal from a utility provider making the rounds to gather meter readings. In some embodiments then, a receiving entity may transmit a wake up signal through the communications infrastructures and the remote enclosure to the utility meter, prompting it to wake up and provide data, such as a meter reading.

In some embodiments, the data received from a receiving entity (block 510) of method 500 may also be used to control when a device, such as an appliance, is turned on or turned off. Merely by way of example, a receiving entity, such as a utility provider or even a customer, may use this method and system to prompt appliances to turn on or off based on the cost of running the appliance based on the cost of using the resource provided by a utility company. Many other purposes may prompt a receiving entity to transmit data through the system to the customer premises such as to remotely control devices, turning on devices for security reasons, monitoring devices to determine utility usage, and/or maintaining devices.

While detailed descriptions of one or more embodiments have been given above, various alternatives, modifications, and equivalents will be apparent to those skilled in the art without varying from the spirit of the invention. Moreover, except where clearly inappropriate or otherwise expressly noted, it should be assumed that the features, devices, and/or components of different embodiments may be substituted and/or combined. Thus, the above description should not be taken as limiting the scope of the invention, which is defined by the appended claims.

What is claimed is:

1. A method for reading a utility meter utilizing broadband infrastructure, comprising:
transmitting utility usage data from a plurality of customer premises to a remote enclosure, attached to a utility pole, using a power line communications infrastructure;
receiving the utility usage data at the remote enclosure, wherein the remote enclosure comprises a digital subscriber line (“DSL”) modem for modulating the utility usage data to be transmitted over a public broadband network infrastructure;
modulating the utility usage data with the DSL modem; and
transmitting the modulated utility usage data over the public broadband infrastructure to a utility provider.

2. A method for determining a utility usage utilizing broadband infrastructure, comprising:
transmitting utility usage data from at least one customer premises to a remote enclosure using a first communications infrastructure;
receiving the utility usage data at the remote enclosure, wherein the remote enclosure comprises a modem for modulating the utility usage data to be transmitted over a second communications infrastructure;
modulating the utility usage data with the modem; and
transmitting the modulated utility usage data over the second communications infrastructure to a receiving entity.

3. The method of claim 2, wherein the remote enclosure is coupled with at least one of a utility pole or a utility box.

4. The method of claim 2, wherein the utility usage data comprises data selected from the group consisting of:
electricity usage data;
water usage data;
gas usage data; and
smart device utility usage data.

5. The method of claim 2, wherein the utility usage data comprises power generation data.

6. The method of claim 2, wherein the receiving entity comprises an entity selected from the group consisting of:
a utility provider;
a service provider; and
a customer.

7. The method of claim 2, wherein the first communications infrastructure comprises a power line communications infrastructure.

8. The method of claim 7, wherein the power line communications infrastructure comprises a broadband over power line communications infrastructure.

9. The method of claim 2, wherein the first communications infrastructure comprises a wireless infrastructure

10. The method of claim 2, wherein the second communications infrastructures comprises a public access network infrastructure.

11. The method of claim 10, wherein the public access network infrastructure is the Internet.

12. The method of claim 2, wherein the modem further comprises a digital subscriber line (“DSL”) modem.

13. The method of claim 2, wherein transmitting the modulated utility usage data over the second communications infrastructure to a receiving entity further comprises transmitting the data securely.

14. The method of claim 13, wherein transmitting the data securely comprises encrypting the data.

15. The method of claim 13, wherein transmitting the data securely comprises using a virtual private network (“VPN”).

16. The method of claim 2, wherein transmitting the modulated utility usage data over the second communications infrastructure to a receiving entity further comprises transmitting the data over a private network using an existing public network.

17. The method of claim 2, further comprising aggregating utility usage data from a plurality of customer premises.

18. The method of claim 2, further comprising:
receiving control data, from the receiving entity, at the remote enclosure through the second communications infrastructure;
transmitting the control data from the remote enclosure to the at least one customer premises through the first communications infrastructure;
controlling at least one device at the at least one customer premises using the control data.

19. A system for determining a utility usage utilizing broadband network, comprising:
a utility meter in communication with a first communications network;
a remote enclosure in communication with the utility meter through the first communications network; and
a digital subscriber line (“DSL”) modem housed within the remote enclosure, wherein the DSL modem is in communication with a local loop of a public switched telephone network in order to transmit utility usage data to a utility provider.

20. The system of claim 19, wherein the remote enclosure is attached to utility pole.

21. The system of claim 19, wherein the remote enclosure is attached to a utility box.

22. The system of claim 19, where in the first communications network is a power line communications network.

23. The system of claim 22, wherein the power line communications network is a broadband over power line communications network.

24. The system of claim 19, where in the first communications network is a wireless network.

25. The system of claim 19, wherein the remote enclosure further comprises network interface device.
